(19) United States
(12) Patent Application Publication
(10) Pub. No.: US 2011/0289089 A1
(43) Pub. Date: Nov. 24, 2011

(54) Negative space finder

(76) Inventors: Mariana Paul Thomas, San Francisco, CA (US); Ajit Peter Thomas, San Francisco, CA (US)

(21) Appl. No.: 12/800,535

(22) Filed: May 18, 2010

(51) Int. Cl. G06F 17/30

(52) U.S. Cl. 707/740; 707/769; 707/E17.014; 707/741; 707/E17.002; 707/E17.09

(57) ABSTRACT

Search engines rely on complex algorithms to search for what is available on the internet. When a query is input, the engine will find matches to the user's search terms and return those matches in ever-expanding circles of relevance. When searches do not return a “true” result that meets the user's needs, the lack of information is ignored. A method for mining unfulfilled searches from search result data and indexing these unfulfilled results in a methodical, way, and a system for such, are disclosed herein. Also disclosed is a method for associating and grouping those unfulfilled searches to specific categories. This results in a database of what is being searched for and not being found. This database can be used for a variety of purposes including, but not limited to, identifying news areas, new product initiation and prioritization, enhanced customer support, and lead generation.

### TECHNICAL FIELD AND INDUSTRIAL APPLICABILITY OF THE INVENTION

This invention relates to the fields of search and categorization of search results. More specifically it relates to using search results as a base data set and extracting unfulfilled searches from the data set, categorizing them, and, optionally, relating them to user profile data.

### BACKGROUND OF THE INVENTION

Search engines today specialize in retrieving data from a source data set based on specific query terms entered by a user. They retrieve the best possible matches for the query with differences in returns that are based on their specific search algorithm. However, search engines today do not identify situations where the query entered by the user is searching for data which is either sparse or non-existent in the source data set. Conceptually, the source data set can be envisioned as topographical map with both mountains (where there is an abundance of data on a topic) and valleys (where data is sparse) and deserts (where data is non-existent). Search engines are optimized to find the closest data to the data being requested, so if the requested data happens to be nonexistent, in a desert, the search engine will retrieve data that is the closest result, that is, from the nearest points outside the desert. (See FIG. 1 for a diagrammatic depiction). In some search engines this data is presented with a probability element that indicate how close to the query the response is. As shown in FIG. 1, query 1 satisfies the customer need by providing a hit or confirmed response to the query, the query 2 does not provide a hit of confirmed response but a response that has a very high probability of being a success, and query 3 shows a very poor probability response that will not satisfy the customer.

These types of searches, where the query gets matched with the result, are valuable, but sometimes it is also valuable to know which data is missing from the source data set and if that data is being requested. There is no organized method of capture of these unfulfilled searches. This can only be achieved today by entering a specific query and manually assessing the results for relevance. These search results are not considered valid results and hence are not processed or tabulated. If it needs to be done it has to be confirmed and tabulated manually by visual inspection of all searches done against a source data set by someone with knowledge of the contents of the source data set. However, as the source data set or number of searches becomes on the set become large, these manual search and compilation techniques will no longer be effective.

### SUMMARY OF INVENTION

Therefore, it would be advantageous to have a method for extraction and compilation of the unfulfilled searches, and it will be especially valuable to have a system and an automated process that identifies queries where searches fail to return relevant results due to a scarcity of data available in the source data sets and compile the results. These “unsatisfied” searches will provide insight into what is being sought without success, or the desert and valley areas of the source data set where searchers have a need or are seeking to explore but cannot find a result. This can be a valuable tool for many applications such as product planning, medical and industrial research, Information and News presentation and many others where knowledge of a need can drive the future activities.

### BRIEF DESCRIPTION OF THE DRAWINGS

FIG. 1—Diagrammatic depiction of prior art search

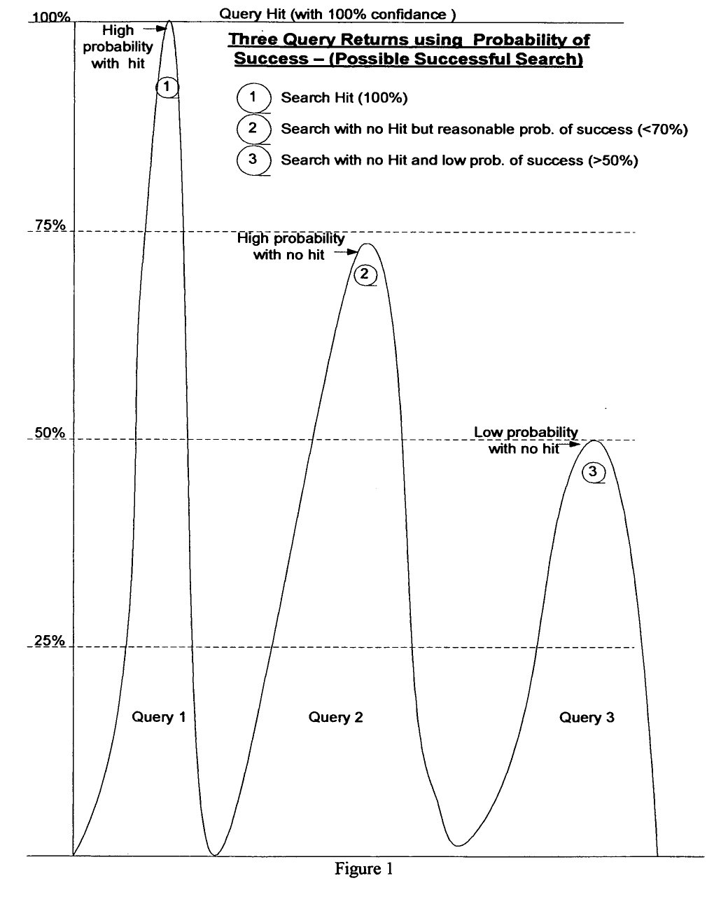

FIG. 2—Exemplary process flow diagram of the proposed search.

FIG. 3—Exemplary system to implement the search and compile the data base.

### DETAILED DESCRIPTION OF THE INVENTION

Search engines rely on complex algorithms to search for what is available on the internet. When a query is input, the engine will find matches to the user's search terms and return those matches in ever-expanding circles of relevance. When searches do not return a “true” result that meets the user's needs, the lack of information is ignored. A method for mining unfulfilled searches from search result data and indexing these unfulfilled results in a methodical, way, and a system for such, are disclosed herein. Also disclosed is a method for associating and grouping those unfulfilled searches to specific categories. This results in a database of what is being searched for and not being found. This database can be used for a variety of purposes including, but not limited to, identifying news areas, new product initiation and prioritization, enhanced customer support, and lead generation.

The invention is a scheme or method and a system to check out and identify from a large number of searches being conducted within any data set, the searches which are not able to provide a result or one that is only able to provide result that have low correlation to the query. When this is compiled this will provide a view of what the searchers are looking for but not finding in the data set. The frequency and repetitive nature of the queries provide an indication of what is being looked for by a set of searchers within any time period. Further a follow up searcher response to any of the non-optimal results, currently not in the system implementation, system will provide an indication of the need for a result by the searcher. Compiling a data base of such search queries will provide valuable information on the unfulfilled need of the searching population and can have applications in marketing, product planning, service needs etc.

The process typically required to identify areas within any given data set that are being sought but provide inadequate information return to the seekers due to the unavailability or scarcity of requested data. These queries, where the return is sparse or irrelevant, is compiled and made into an unfulfilled data base that is usable for many purposes. A method and system for such an implementation is disclosed below. The process is executed as often as necessary, or even in a continuously repetitive manner in order to provide the most accurate view of the changing data topography. It is envisaged that this will be executed in real-time on search request for optimum results.

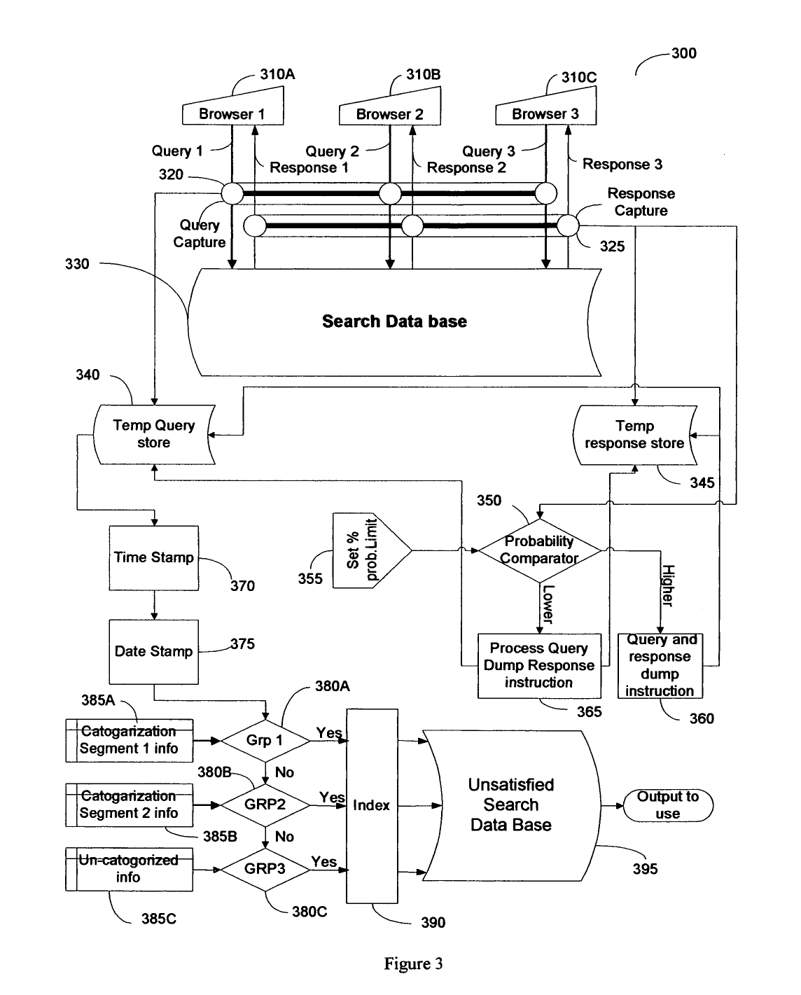

FIG. 3 is an exemplary and non limiting search system 300 of the current invention. Browsers 301A, 310B and 310C input search queries into the search system. These queries run searches on the indexed search data base 330 and return search results. Query capture nodes 320 and result capture nodes 325 capture each query presented and its result. The queries are stored in temporary query storage 340 and the associated response in temporary response storage 345. At the same time the response is checked against a reference set success probability or confidence limit 355, for the result, set in a probability comparator 350. If the result has a higher probability value than the set probability value, a first instruction generator 360 instructs the temporary query storage 340 and the temporary response storages 345 to dump both the query and the response from storage. If the result of the probability comparator is lower, then a second instruction generator 365 instructs the temporary response storage 345 to dump the stored response but instructs the temporary query storage to process the query further. The stored query is time stamped in a time stamp block 370 and date stamped in a date stamp block 375. The query is then compared against categorization info 385A to 385C in a set of comparators 380A to 380C and grouped into the multiple categories. The queries are indexed in group categories in an indexer 395 and stored in an unsatisfied search data base 390 for use.

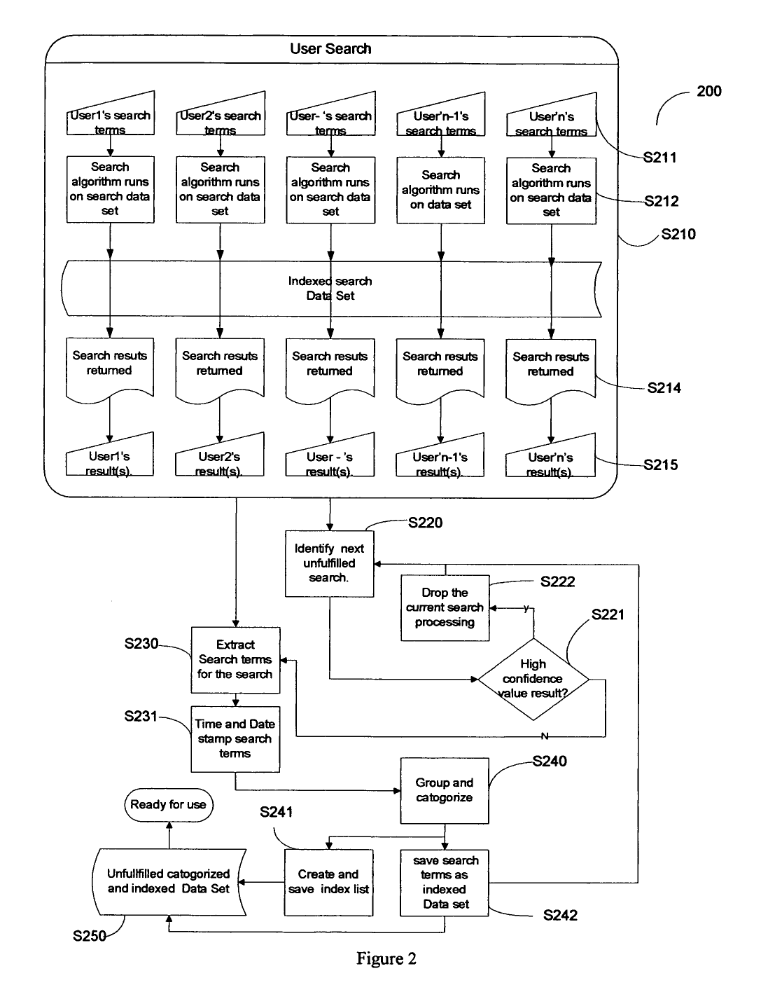

FIG. 2 is an exemplary flow diagram 200 of the method for search and compilation. The standard searches S210 comprise input of query with search terms S211 by searchers. These search terms are used by the search algorithm to run a search on an indexed data set which is either stored on line or in the system in the indexed data store S212. The search results are returned as an output to the output devices of the search system 210 for the searches S214. The results are then sent to the searchers to selects the result that is significant for him or rejects the results ending basic query search S215.

In order to identify the unfulfilled search as per the current invention the results of all the unfulfilled searches are collected S220. These are checked one by one to see if the results of the searches produced high confidence value result which would indicate a high probability of success or low confidence value result which would indicate a low probability of success S221. If the confidence level is high the results are rejected as being a candidate for the unfulfilled data base and next result check is initiated S222. If the result shows low confidence level, the search terms or query for the search is extracted S230. These search terms are time and date stamped S231. These are then grouped and categorized based on available grouping criteria S240. Typically an index list is generated that include the group and category of the search and saved S241. The search terms are now saved as an indexed unsatisfied search data set. The process is then repeated for the next unfulfilled search result. The data in the unfulfilled categorized Data Store is now ready for use S250.

The time and date stamps are used to age and delete the information stored to keep the unsatisfied search data set current.

Such an invention can be implemented on a computer system using computer code, a hardware implementation or a firmware implementation. Typical implementation details described are only meant as a possible implementation of the exemplary and non limiting method and system and are again not meant to be limiting. Other implementations to achieve the desired results may be known to search algorithm experts and these forms of implementations are covered under the application. Follow up on the next search after an unsuccessful one by the same searcher etc to improve usability are possible to be implemented as improvement, depending on application requirements, these improvements and additions that are known to practitioners of the art are made part of the invention. Even though only a few uses of the resultant compilation have been mentioned, it is also not meant to be limiting. Applications of the compiled data are large and new applications are expected to emerge as the capability is established. Any such applications of the search result that will be known to practitioners of the art and which may emerge with availability are also covered as part of the application.

What is claimed is:

1. A method of identifying search results comprising:
inputting search query terms;
running a search algorithm using said search query terms against an indexed data set;
receiving a search result output;
checking for a suitable search result or a high confidence search result, available for selection of a valid response;
identifying said search as an unfulfilled search where said search result has not returned said valid response; and
compiling and storing said queries for said unfulfilled searches;
such that the said queries submitted to said data set during said search process that are unfulfilled can be identified, categorized and indexed for storage and use.

2. The method of claim 1, wherein low confidence value results are used to identify unfulfilled searches.

3. The method of claim 1, wherein said unfulfilled queries are grouped and categorized before compiling and storing.

4. The method of claim 1, wherein said unfulfilled queries are time and date stamped prior to compiling and storing.

5. The method of claim 1, wherein said unfulfilled queries are stored in an indexed data base.

6. A system to collect and store queries of unfulfilled searches comprising:
means for collecting search queries and responses from a data base search;
means for temporarily storing said search queries and said responses;
means for checking said responses to identify unfulfilled searches;
means for categorizing and indexing said search queries of said identified unfulfilled searches; and
means for storing said categorized and indexed said search queries of said identified unfulfilled searches;
such that an unfulfilled indexed search data base can be generated for use.

7. The system of claim 6, wherein said search queries are collected from said data base search by a query capture circuit.

8. The system of claim 6, wherein said responses are collected from said data base search by a response capture circuit.

9. The system of claim 6, wherein means for checking said responses to identify unfulfilled searches comprise;
a probability comparator connected to said temporary storage for said responses;
a probability set limit connected to said probability comparator;
such that said probability comparator is enabled to compare said probability set limit against a confidence limit for each said response and decide if a search providing said response is unfulfilled or not.

10. The system of claim 6, wherein said search queries of said unfulfilled searches are grouped based on categorization segment information.

11. The system of claim 6, wherein said search queries of said unfulfilled searches are indexed prior to storage.

12. The system of claim 11, wherein said indexing is based on said groups.

13. The system of claim 6, wherein said search queries of said unfulfilled searches are saved in an unsatisfied search data base.

14. The system of claim 6, wherein said search queries of said unfulfilled searches are date and time stamped prior to storage in said unsatisfied search data base.

15. The system of claim 14, wherein said date and time stamps are used to keep said unsatisfied search data base current.
